(19) United States
(12) Patent Application Publication
(10) Pub. No.: US 2026/0366580 A1
(43) Pub. Date: Nov. 19, 2026

(54) DISCONNECT ACTUATOR WITH PERMANENT MAGNETS ON THE OUTSIDE DIAMETER

(71) Applicant: BorgWarner Inc., Auburn Hills, MI (US)

(72) Inventors: Dean J. Schneider, Washington, MI (US); Larry A. Pritchard, Macomb, MI (US)

(21) Appl. No.: 19/208,134

(22) Filed: May 14, 2025

(51) Int. Cl. F16D 27/00; F16D 27/14

(52) U.S. Cl. CPC F16D 27/004; F16D 27/14; F16D 2027/001

(57) ABSTRACT

An actuator assembly includes a ring-shaped electromagnetic coil having a coil axis and an outside diameter, and first and second ring-shaped permanent magnet assemblies arranged in parallel about the outside diameter and separated by a separator ring and whose respective magnetic polarities are opposing. A housing encloses the electromagnetic coil, the first and second permanent magnet assemblies, and the separator ring. An armature is configured for linear movement and is disposed in one of a first position adjacent the first permanent magnet assembly or a second position adjacent the second permanent magnet assembly. The coil is configured to produce a magnetic field by an electric current flowing therethrough and wherein the armature is responsive to the produced magnetic field to become magnetically latched in one of the first axial position or the second axial position based on a direction of the electric current.

### TECHNICAL FIELD

The present application relates generally to an actuator and more particularly to a disconnect actuator with permanent magnets on the outside diameter.

### BACKGROUND

This background description is set forth below for the purpose of providing context only. Therefore, any aspects of this background description, to the extent that it does not otherwise qualify as prior art, is neither expressly nor impliedly admitted as prior art against the instant disclosure.

There is a desire for selectively disconnecting an automotive wheel from a power transmission source in, for example, an electric vehicle. This involves positively separating the wheel from the power transmission source. One approach for achieving separation involves positioning a clutch (e.g., a dog clutch) in the drivetrain between a drive motor (i.e., the power transmission source) and the wheel. The clutch, when open or disengaged, breaks the power transmission path to the wheel while when closed or engaged, allows power delivery to the wheel. The above-mentioned dog clutch typically involves at least a couple of cooperating components wherein at least one of the components is translated axially between engaged and disengaged positions.

It would be useful to provide a device that can be used to effect the above-mentioned axial translation of a dog clutch component.

### SUMMARY

In one implementation, an actuator is provided that includes an electromagnetic coil having a coil axis where the coil is ring-shaped having an outside diameter, a first permanent magnet assembly arranged as a first ring, a separator ring, and a second permanent magnet assembly arranged as a second ring parallel to the first ring wherein the first and second permanent magnet assemblies are arranged about the outside diameter of the coil separated by the separator ring and having respective magnetic polarities that are opposing. The actuator further includes a housing configured to enclose the electromagnetic coil, the first and second permanent magnet assemblies, and the separator ring, and an armature proximate the first and second permanent magnet assemblies configured for axial movement. The armature is disposed in one of a first axial position adjacent the first permanent magnet assembly or a second axial position adjacent the second permanent magnet assembly. The electromagnetic coil is configured to produce a magnetic field by an electric current flowing therethrough and wherein the armature is responsive to the produced magnetic field to be magnetically latched in one of the first axial position or the second axial position based on a direction of the electric current flowing through the coil.

The foregoing and other aspects, features, details, utilities, and advantages of the present disclosure will be apparent from reading the following description and claims, and from reviewing the accompanying drawings.

### BRIEF DESCRIPTION OF THE DRAWINGS

FIG. 1 is an isometric view of an actuator assembly, in an implementation;

FIG. 2 is a sectional view of the actuator assembly of FIG. 1;

FIG. 3 is an enlarged, cross-sectional view of the encircled portion of FIG. 2 identified as 3; and

FIG. 4 is a schematic and block diagram showing how the actuator assembly of FIGS. 1-3 can be used in an electric vehicle.

### DETAILED DESCRIPTION

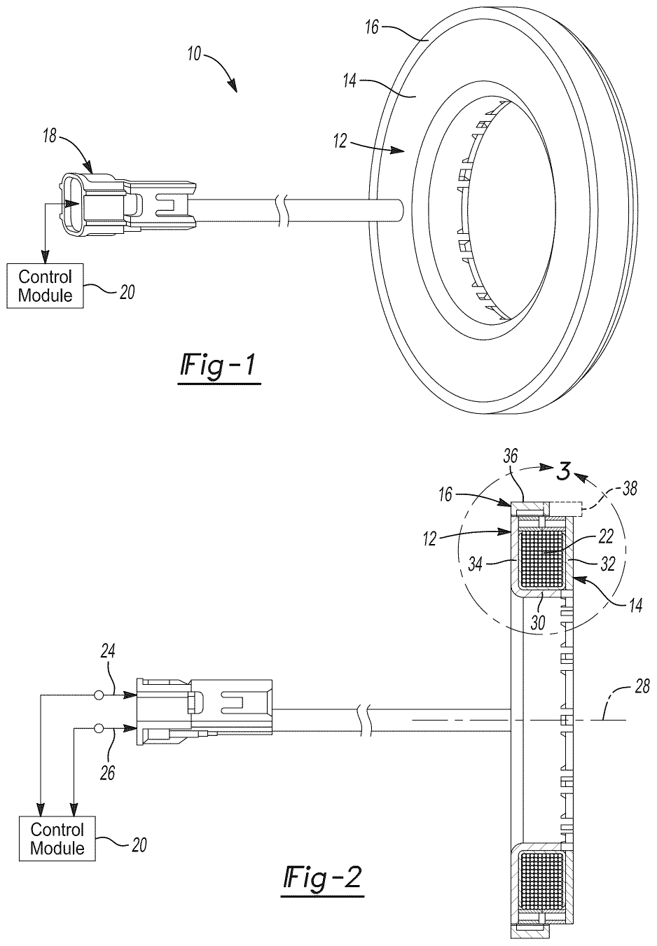

Referring now to the drawings wherein like reference numerals are used to identify identical or similar components in the various views, FIG. 1 is an isometric view of an electrically operated actuator assembly 10, in an implementation. The actuator assembly 10 can be configured to engage and disengage a clutch, such as a dog clutch, for example, to selectively connect and/or disconnect a rotary power source to/from a destination for such rotary power (i.e., a disconnect actuator in such an application). The actuator assembly 10 includes a stator 12 having a housing 14, an armature 16, and an electrical connector 18. An electronic control module 20 can be configured to control an electric current, including the direction of the electric current, flowing through the actuator assembly 10. In this regard, the electronic control module 20 can be electrically connected to the actuator assembly 10 via connection to the electrical connector 18. Control of the direction (and magnitude) of the electric current can be used to cause the armature 16 of the actuator assembly 10 to move back and forth between a first axial position (shown in FIG. 1) and a second axial position (best shown in FIG. 2 in dashed-line format). The control module 20 may include control and power related electronics (e.g., such as power switching devices) to control the operation of the actuator assembly 10 as described herein.

FIG. 2 is a sectional view of the actuator assembly 10 of FIG. 1. The stator 12 further includes an electromagnetic coil 22, which comprises an electrical conductor such as electrically-conductive wire that has a first end 24 and a second, opposite end 26. The first and second ends 24, 26 are shown diagrammatically in FIG. 2, and can be electrically connected to the control module 20 via the connector 18. The connector 18 is configured to provide electrical terminations with respect to the first and second ends of the electromagnetic coil 22. The electromagnetic coil 22 as incorporated into the actuator assembly 10 may be generally ring-shaped having a coil axis 28.

The housing 14 is configured to receive the stator components and includes a base 30, which extends into a first sidewall 32 and a second sidewall 34 that is axially spaced apart from the first sidewall 32 to form a generally U-shaped (in cross-section) container. In an implementation, the housing 14 may comprise ferromagnetic material since the housing 14 forms part of the magnetic circuits as described herein. During operation, the armature 16 will assume one of either a first axial position 36 (shown in solid line format) or a second axial position 38 (shown in dashed line format) in accordance with an electric current that flows through the electromagnetic coil 22 and a direction of the electric current, as described herein.

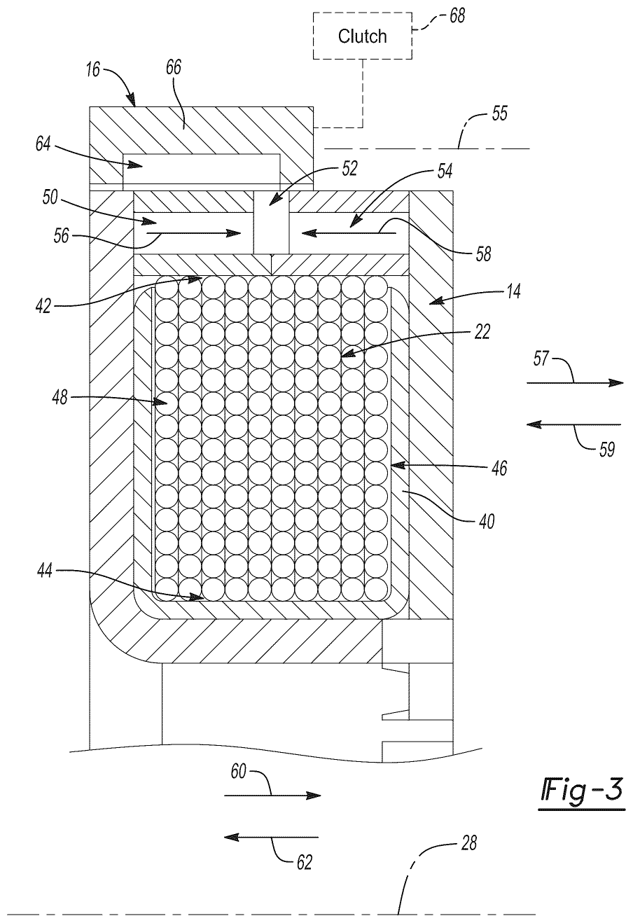

FIG. 3 is an enlarged cross-sectional view of the actuator assembly 10 showing an encircled portion in FIG. 2, identified at “3”, in greater detail. The stator 12 further includes a spool 40 defining a space configured to receive the electromagnetic coil 22. In an implementation, the spool 40 is generally ring-shaped and comprises a generally U-shaped spool in radial cross-section. The spool 40 may comprise electrically-insulating material.

The electromagnetic coil 22 is disposed in the spool 40 wherein the coil 22 has an outside diameter 42, an inside diameter 44, a first axial side 46, and a second axial side 48 that is axially spaced apart from the first axial side 46. The electromagnetic coil 22 may have a specified number of turns, which may be determined as a function of a number of factors, including but not limited to a desired magnetic field strength to be generated when energized, a desired magnitude of electric current to flow through the electromagnetic coil 22 when energized, and other factors as well.

The stator 12 further includes a first permanent magnet assembly 50 arranged as a first ring, a separator ring 52, and a second permanent magnet assembly 54 arranged as a second ring parallel to and axially spaced apart from the first ring (i.e., the first permanent magnet assembly 50) by the separator ring 52. In the illustrated implementation, the first and second permanent magnet assemblies 50, 54 are arranged about the outside diameter 42, and more particularly, arranged radially outwardly of the outside diameter 42. Additionally, in an implementation, the first and second permanent magnet assemblies 50, 54 may each comprise a respective set (i.e., a respective plurality) of individual permanent magnets. The separator ring 52 may comprise electrically conductive material.

The first permanent magnet assembly 50 has a first magnetic polarity 56 associated therewith and the second permanent magnet assembly 54 has a second magnetic polarity 58 associated therewith wherein the first and second magnetic polarities 56, 58 are opposing. In the illustrated implementation, the first and second magnetic polarities 56, 58 may be taken as being axially oriented magnetic poles where the same pole (i.e., either the “N” pole or the “S” pole thereof) face each other. This is shown as the respective arrowheads of the polarities 56, 58 confronting each other.

The stator 12 thus includes the electromagnetic coil 22, the spool 40, the first and second permanent magnet assemblies 50, 54, and the separator ring 52. The housing 14 is configured to generally enclose the components of the stator 12 as well forming a part of various magnetic circuits.

The armature 16 is configured for substantially axial, linear movement along an armature axis 55 that is parallel to but radially spaced apart from the coil axis 28. The linear movement can be in both a first axial direction 57 and in a second axial direction 59 that is opposite the first direction. The armature 16 may be mechanically coupled to the stator 12 in conventional ways known in the art. In an implementation, the armature may be connected to one component transmitting power. The connection may be a splined connection wherein the dog clutch slides axially on the splines maintaining its radial position thereof. The stator 12 may be rigidly held in the housing 14. The armature 16 is thus configured for bi-directional linear, axial movement.

The armature 16 may include an armature core 64 comprising for example ferromagnetic material and a component of a dog clutch 68 (e.g., a shift collar 66). In other words, the armature 16 comprises the armature core 64 and one component of the dog clutch 68, for example, the shift collar 66. The armature portion 64 may be connected to one side of the dog clutch shift collar 66. An additional component (isolator-not shown) may be used if item 66 is magnetic. The armature 16 in the illustrated implementation is disposed radially outwardly of the first and second permanent magnet assemblies 50, 54. The armature 16 can be arranged about one of the first axial position 36 (FIG. 2) that is adjacent the first permanent magnet assembly 50 or the second axial position 38 (FIG. 2) that is adjacent the second permanent magnet assembly 54. The armature 16 can be magnetically latched in either one of the first and second axial positions 36, 38 about the respective one of the first and second permanent magnet assemblies 50, 54. In the illustrated implementation, the armature 16 is arranged in the first position 36 (FIG. 2) about and adjacent to the first permanent magnet assembly 50.

The first permanent magnet assembly 50 has a first axial extent (i.e., a first width) and the second permanent magnet assembly 54 has a second axial extent (i.e., a second width). The armature 16 in the first axial position 136 substantially axially overlaps the first permanent magnet assembly 50 over the first axial extent. Additionally, the armature 16 in the second axial position 138 substantially axially overlaps the second permanent magnet assembly 54 over the second axial extent.

The electromagnetic coil 22 is arranged in the housing 14 such that when combined with the first and second permanent magnet assemblies 50, 54 and the separator ring 52, establish a magnetic circuit with the armature 16. The electromagnetic coil 22 is configured to create a magnetic field when an electric current is passed therethrough. The orientation (direction) of the magnetic field polarity is generally axially pointing and is switchable based on the direction of the electric current flowing through the electromagnetic coil 22. In the illustrated implementation, the electromagnetic coil 22 is configured to produce a magnetic field having a first (coil-produced) polarity 60 when electric current is passed through the coil 22 in a first direction while the magnetic field has a second (coil-produced) polarity 62 when the electric current is passed through the coil 22 in a second direction that is opposite of the first direction. The first and second polarities 60, 62 are generally axially oriented as illustrated. Thus, the first and second polarities 60, 62 are based on at least the direction of the electric current flowing through the electromagnetic coil 22. In an implementation, the first direction of the electric current may be taken as flowing from the first end 24 (FIG. 2) of the coil 22 to the second end 26 (FIG. 2), while the second direction of the electric current may be taken as flowing from the second end 26 to the first end 24. It should understood that the foregoing first and second directions are arbitrary and may be reversed without loss of generality.

In operation, the armature 16 is linearly and axially translated by passing electric current of a sufficient magnitude through the electromagnetic coil 22 such that the resulting coil-produced magnetic field strength opposes and effectively substantially diminishes and/or cancels entirely the magnetic field produced by one of the first or second permanent magnet assemblies 50, 54. This decrease and/or cancellation may be seen at a schematic level by the permanent magnet-produced magnetic field polarities 56, 58 on the one hand, as compared to the electromagnetic coil-produced magnetic field polarities 60, 62.

The magnetic field lines form continuous closed loops. Conventionally, the magnetic field lines are taken as extending from the north “N” pole to the south “S” pole outside of the magnetic field source itself. Thus, magnetic field lines originating from different sources but extending directionally in opposite directions in the same vicinity will tend to cancel while those magnetic field lines that are directionally headed in the same direction in the same vicinity will tend to be additive. The armature 16 is thus translated due to the magnetic field created by the electromagnetic coil 22 combined with the magnetic field of the other, non-weakened/non canceled permanent magnet assembly. For example, when the permanent magnet assembly 50 has its magnetic field weakened/canceled, the magnetic field produced by the other permanent magnet assembly 54 combines with the magnetic field produced by the electromagnetic coil 22, and vice-versa. When translated, the armature 16 leaves the magnetic circuit of one of the permanent magnet assemblies and surrounding components and becomes a part of a magnetic circuit with the other permanent magnet assembly and surrounding components, effectively latching the armature 16 in that position (i.e., the first axial position 136 or the second axial position 138, as the case may be). The axial direction of the translation of the armature 16 can be reversed depending on the current axial position of the armature 16 and the direction of the electric current passing through the electromagnetic coil 22.

It should be appreciated that the translation of the armature 16 as described herein may be used to move one or more components of a clutch 68.

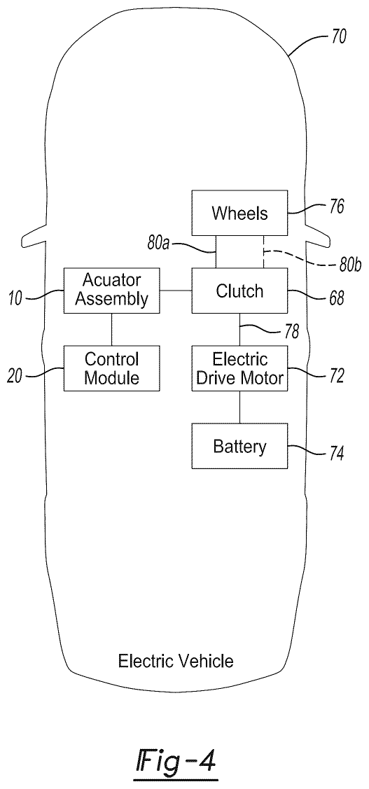

FIG. 4 is a schematic and block diagram showing how the actuator assembly 10 can be used in an electric vehicle 70. FIG. 4 shows the actuator assembly 10, the control module 20, an electric drive motor 72 electrically coupled to an electric battery 74, and one or more drive wheels, designated 76. In one application, the clutch 68 may be a dog clutch. Rotary power from the electric drive motor 72, such as a rotating motor output shaft 78, is mechanically coupled to an input component of the dog clutch 68. An output component of the dog clutch 68 is coupled to the wheel(s) 76.

The armature 16 may be mechanically coupled to one or more components of the clutch 68, wherein the actuator assembly 10 can be selectively controlled by the control module 20 to axially move (as described herein) the armature 16 between the above-mentioned first and second axial positions 136, 138, resulting in corresponding movement of the clutch components (not shown) to which the armature 16 is attached. Movement of the armature 16 is configured so as to place the clutch components (not shown) of the clutch 68 in either an engaged position or a disengaged position. In the engaged position, the input component of the clutch 68 and the output component of the clutch 68 are engaged so that rotary power from the drive motor 72, via the shaft 78, can be transferred to the wheel(s) 76 via a mechanical connection 80a. In the disengaged position, the input component and the output component of the clutch 68 are disengaged wherein the output component of the clutch 68 is disconnected from the input component (i.e., the motor shaft 78) to thereby disconnect the wheel(s) 76 from the rotary power provided by the motor shaft 78. This disconnected mechanical connection is shown in broken line format and is designated 80b. It should be understood that variations are possible (e.g., multiple actuator assemblies 10 may be used in different arrangements in the vehicle 70).

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. An actuator, comprising:
an electromagnetic coil having a coil axis, the coil being ring-shaped and having an outside diameter;
a first permanent magnet assembly arranged as a first ring;
a separator ring;
a second permanent magnet assembly arranged as a second ring parallel to the first ring wherein the first and second permanent magnet assemblies are arranged about the outside diameter of the coil separated by the separator ring and having respective magnetic polarities that are opposing;
a housing configured to enclose the electromagnetic coil, the first and second permanent magnet assemblies, and the separator ring; and
an armature, coupled to the first permanent magnet assembly or the second permanent magnet assembly via a slidable coupling that is disposed radially outwardly from the electromagnetic coil, configured for axial movement, the armature being disposed in one of a first axial position adjacent the first permanent magnet assembly or a second axial position adjacent the second permanent magnet assembly;
wherein the electromagnetic coil is configured to produce a magnetic field by an electric current flowing therethrough and wherein the armature is responsive to the produced magnetic field to become magnetically latched in one of the first axial position or the second axial position based on a direction of the electric current flowing through the coil.

2. The actuator of claim 1 wherein the first and second permanent magnet assemblies each comprise a respective plurality of individual permanent magnets.

3. The actuator of claim 1 wherein the separator ring comprises electrically conductive material.

4. The actuator of claim 1 wherein the electromagnetic coil comprises an electrical conductor having a first end and a second, opposite end, and wherein the direction of the electric current comprises a first direction from the first end to the second end and a second direction opposite the first direction from the second end to the first end.

5. The actuator of claim 4 wherein the magnetic field produced by the electromagnetic coil has a first magnetic polarity when the electric current flows in the first direction and has a second magnetic polarity opposite the first magnetic polarity when the electric current flows in the second direction.

6. The actuator of claim 1 wherein the armature comprises ferromagnetic material.

7. The actuator of claim 1 wherein the armature is ring-shaped.

8. The actuator of claim 7 wherein the armature is disposed radially outwardly of the first and second permanent magnet assemblies.

9. The actuator of claim 1 further comprising a spool defining a space configured to receive the electromagnetic coil.

10. The actuator of claim 9 wherein the spool comprises an U-shaped spool.

11. The actuator of claim 1 further comprising a connector configured to provide terminations for first and second ends of the electromagnetic coil.

12. The actuator of claim 1 wherein the first permanent magnet assembly is axially spaced apart from the second permanent magnet assembly.

13. The actuator of claim 1 wherein the linear movement of the armature comprises movement in a first axial direction and movement in a second axial direction opposite of the first axial direction.

14. The actuator of claim 1 wherein at least the armature is configured to be coupled to a clutch of a power transmission arrangement and wherein the armature movement in the first and second axial directions engages and disengages the clutch

15. An actuator assembly, comprising:
a stator including
an electromagnetic coil having a coil axis and including an electric conductor with a first end and a second, opposite end, the coil being ring-shaped and having an outside diameter;
a first permanent magnet assembly arranged as a first ring;
a separator ring;
a second permanent magnet assembly arranged as a second ring parallel to the first ring wherein the first and second permanent magnet assemblies are arranged about the outside diameter of the coil separated by the separator ring and having respective magnetic polarities that are opposing;
a housing configured to enclose the electromagnetic coil, the first and second permanent magnet assemblies, and the separator ring; and
an armature, coupled to the first permanent magnet assembly and the second permanent magnet assembly via a slidable coupling that is and being disposed radially outwardly from the electromagnetic coil, the armature being configured for linear, axial movement and is disposed in one of a first axial position adjacent the first permanent magnet assembly or a second axial position adjacent the second permanent magnet assembly, and wherein the electromagnetic coil is configured to produce a magnetic field by an electric current flowing therethrough and wherein the armature is responsive to the produced magnetic field to become magnetically latched in one of the first axial position or the second axial position based on a direction of the electric current flowing through the coil.

16. The actuator assembly of claim 15 wherein the first and second permanent magnet assemblies each comprise a respective plurality of individual permanent magnets.

17. The actuator assembly of claim 15 wherein the direction of the flow of electric current comprises a first direction from a first end of the electromagnetic coil to a second end of the electromagnetic coil that is opposite of the first end, and a second direction from the second end to the first end.
